(19) United States
(12) Patent Application Publication
(10) Pub. No.: US 2006/0152138 A1
(43) Pub. Date: Jul. 13, 2006

(54) Light-emitting element and display device

(76) Inventors: Kenya Hori, Okayama (JP); Masayuki Ono, Osaka (JP); Kumio Nago, Nara (JP); Toshiyuki Aoyama, Osaka (JP); Kenji Hasegawa, Osaka (JP); Masaru Odagiri, Hyogo (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 10/562,796

(22) PCT Filed: Jul. 1, 2004
(86) PCT No.: PCT/JP04/09668

§ 371 Date: Dec. 29, 2005

(30) Foreign Application Priority Data
Jul. 2, 2003 (JP) 2003-190408

(51) Int. Cl. H01J 1/62

(52) U.S. Cl. 313/503

(57) ABSTRACT

A phosphor element includes a pair of electrodes opposed to each other and a phosphor layer sandwiched between the pair of electrodes and having silicon fine particles whose average particle diameter is not more than 100 nm, and at least a part of a surface of the silicon fine particle is covered with a conductive material. In addition, the conductive material may include an oxide or a composite oxide containing at least one element selected from a group of indium, tin, zinc, and gallium.

### TECHNICAL FIELD

The present invention relates to a phosphor element including a phosphor inorganic material and a display device using the phosphor element.

### BACKGROUND ART

There is a display device using an electro luminescent (hereinafter referred to as EL) element, as a display device in a flat panel display which has been focused on together with a liquid crystal panel, a plasma display and the like. The EL element includes an inorganic EL element using an inorganic compound as a light emitter and an organic EL element using an organic compound as the light emitter. The EL element has high-speed response, high contrast, vibration resistance and the like. Since the EL element has no gas in itself, it can be used under high or low pressure.

According to the EL element, although certain gradient can be implemented by driving in an active matrix method using a thin film transistor (TFT) because its driving voltage is low, the element is easily influenced by moisture and the like, so that it has a short life. In addition, the inorganic EL element is characterized in that it has a long life, a wide operating temperature range and excellent decay durability as compared with the organic EL element. Meanwhile, since a voltage required to emit light in the inorganic EL element is as high as 200V to 300V in general, it is difficult to drive it in the active matrix method using the thin film transistor (TFT). Therefore, the inorganic EL element has been driven by a passive matrix method.

According to the passive matrix driving, a plurality of scan electrodes extending parallel to a first direction and a plurality data electrodes extending parallel to a second direction which is perpendicular to the first direction are provided, a phosphor element is sandwiched between the scan electrode and the data electrode which intersect with each other, and one phosphor element is driven when an AC voltage is applied between the pair of scan electrode and data electrode. Since average luminance becomes low as a whole of the display device as the number of the scanning lines is increased in the passive matrix driving, it is necessary to improve the luminance as the phosphor element. In addition, the inorganic light emitter is provided by doping a phosphor material in an insulator crystal in general and it emits light when UV light is irradiated, but even when an electric field is applied, electrons are not likely to be spread and reaction against charging is strong, so that a high-energy electron is needed to emit light. Therefore, it is necessary to take measures to emit light with low-energy electrons.

According to the technique described in Japanese Patent Publication No. 54-8080, Mn, Cr, Tb, Eu, Tm, Yb or the like is doped in a phosphor layer including ZnS mainly to drive (flash) an inorganic EL element, so that emission luminance can be improved, but since it can be driven at high voltage of 200V to 300V only, the TFT cannot be used.

In addition, Japanese Patent Laid-open Publication No. 8-307011 discloses a phosphor element using silicon fine particles. According to the phosphor element, since a size of the silicon fine particle is very small such as 50 nm, a quantum effect is generated and a band gap width becomes a visible light region. Thus, the light is emitted in the visible light region.

### SUMMARY OF THE INVENTION

When the phosphor element is used as a high-quality display device in a television and the like, it is necessary to drive the phosphor element at a low voltage so that the TFT can be used.

It is an object of the present invention to provide a phosphor element which can be driven at a low voltage and can use a thin film transistor.

A phosphor element according to the present invention includes a pair of electrodes opposed to each other, a phosphor layer sandwiched between the pair of electrodes and having silicon fine particles whose average particle diameter is not more than 100 nm. Then, at least a part of a surface of the silicon fine particle is covered with a conductive material.

When an external electric field is applied to the phosphor layer and electrons are spread in silicon fine particles, silicon emits light by a quantum effect. In this case, the inventor of the present invention found that when a surface of the silicon fine particle having a particle diameter of 100 nm or less was covered with a conductive material, the electrons could be easily spread in the silicon fine particles and light was emitted at a low voltage.

Each component of the phosphor element according to the present invention will be described.

The phosphor element may be fixed onto a substrate. The substrate is formed of a material having high electric insulation. When light of the phosphor element is emitted from the substrate side, the substrate is formed of a material having high optical transparency in a visible region. When a temperature of the substrate reaches several hundred of ° C. at a manufacturing step of the phosphor element, a material which has a high softening point, excellent heat resistance and thermal expansion coefficient which is almost the same as that of a laminated layer is to be used. Although glass, ceramics, a silicon wafer may be used in such substrate, non-alkali glass may be used so that alkali ion and the like contained in normal glass may not affect the phosphor element. In addition, alumina and the like may be coated on a glass surface as an ion barrier layer of alkali ion for the phosphor element.

The electrode is formed of a material in which an electric conduction property is high and there is no migration of ion by the electric field. For example, aluminum, molybdenum, tungsten may be used for the electrode. Since the electrode of the phosphor element on the phosphor side may be formed of a material having high transparency in the visible region in addition to the above performance, an electrode mainly formed of tin doped indium oxide (ITO) and the like can be used for the above electrode. In addition, when both of the pair of electrodes are transparent electrodes, both-side phosphor element can be provided. Furthermore, the phosphor element and the display device according to the present invention may be driven by a DC current, an AC current or a pulse.

For the conductive material, conductive inorganic material which is transparent in the visible region can be used. It is preferable that the conductive material includes an oxide or a composite oxide containing at least one element selected from a group of indium, tin, zinc, and gallium. The oxide material may include Ga₂O₃, GaInO₃, In₂O₃, SnO₂, In₄Sn₃O₁₂, ZnO, CdIn₂O₄, Cd₂SnO₂, Zn₂SnO₄, MgIn₂O₄, ZnGa₂O₄, CdGa₂O₄, CaGa₂O₄, AgInO₂, InGaMgO₄, InGaZnO₄, and the like. In addition, as another example, it is preferable that the conductive material includes a nitride (for example, titanium nitride) or a composite nitride containing at least one element selected from a group of titanium, zirconium, hafnium, gallium, and aluminum. As still another example, a thin film of metal such as gold, silver, platinum, copper, rhodium, palladium, aluminum, chrome and the like or an alloy containing mainly the above (magnesium silver alloy, for example) may be used. In addition, the silicon fine particles having the conductive material on at least one part of its surface may be dispersed in a transparent conductor matrix material. The transparent conductor matrix material preferably includes polyacetylene series; polyphenylene series such as polyparaphenylene, polyphenylenevinylene, poliphenylenesulfide, polyphenyleneoxide; heterocyclic polymer series such as polypyrrole, polythiophene, polyfurane, polyselenophene, polytellurophene; ionic polymer series such as polyaniline; polyacene series; polyester series; metal phthalocyanine series, these derivative, copolymer and mixture, and the like. As a more preferable example, there are poly-N-vinylcarbozole (PVK), polyethylenedioxythiophene (PEDOT), polystyrenesulfonate (PPS), polymethylphenylsilane (PMPS) and the like. Furthermore, a polymer having electron transport property which will be described in detail below may be used. Still furthermore, its electro conductivity may be adjusted by dispersing low-molecular organic material having the electron transport property, or conductive or semi-conductive inorganic material, in the conductive or semi-conductive polymer.

An electron transport layer formed of the material including the electron transport property may be formed between the electrode and the phosphor layer. The material including the electron transport property is a material having high electron mobility, which can promptly transport electrons in the electron transport layer. In a case of the organic material, a material mainly including aluminum quinolinate or oxadiazole derivative may be used, and in a case of the inorganic material, a single-crystalline body, polycrystalline body of an n-type semiconductor material and a resin diffused layer and the like of its particle powder can be used.

An electron hole transport layer formed of a material having electron hole transport property may be formed between the electrode and the phosphor layer. The electron hole transport layer may be provided between the electrode serving as a positive electrode and the phosphor layer. The material having the electron hole transport property is a material having high electron hole mobility, which promptly transports the electron hole in the electron hole transport layer, and a material mainly including polyvinyl carbozole series or polyphenylenevinylene series may be used.

A constitution of the phosphor element according to the present invention will be described.

As shown in FIG. 1, the phosphor element includes a phosphor layer containing silicon fine particles having at least one part of the surface covered with the conductive material as the light emitter, between the pair of electrodes opposed to each other. That is, the phosphor element has a fundamental constitution in which the phosphor layer is sandwiched between the pair of electrodes and each electrode is connected to a power supply. In addition, the electrode may be formed on the substrate. Furthermore, the silicon fine particles having a surface covered with the conductive material may be dispersed in the transparent conductor matrix. In addition, the electron transport layer may be provided between the electrode and the phosphor layer. Furthermore, an electron injection layer may be provided between the electron transport layer and the electrode. In addition, the electron hole transport layer may be provided between the electrode serving as the positive electrode and the phosphor layer. Still furthermore, the electron hole injection layer may be provided between the electron hole transport layer and the positive electrode. Since the phosphor element is driven at the low voltage, when the thin film transistor (TFT) is provided in the structure, the display can implement active matrix driving at the low voltage.

Next, a condition to provide sufficient emission efficiency in the phosphor element will be discussed. The phosphor element is driven when the external electric field is applied to the electrode of the phosphor element, and the electrons are transported to the light emitter in the phosphor layer by the applied external electric field. Since the silicon fine particles having a size of 100 nm or less are provided in the center of the light emitter, when the electrons are spread in the center of the light emitter, silicon is excited by the quantum effect to emit light. Since the surface of the silicon fine particle is covered with the conductive material, the electrons are easily spread in the silicon fine particles of the center.

Here, the silicon fine particles are excited by transmitted electron energy, and then, the silicon fine particle emits light when it is changed from excited state to ground state. That is, as the particle diameter of the silicon fine particle becomes small, the quantum effect is more provided to enlarge the band gap. Thus, although the silicon fine particle having a particle diameter 100 nm or less emits light in a visible light region, as the particle diameter becomes small, its surface area is increased and the particles become unstable. Therefore, it is necessary to cover the silicon fine particle surface in order to keep the small particle diameter stably. In this case, it is preferable that the surface of the silicon fine particle is covered with the conductive material. Thus, energy can be effectively transmitted to the silicon atoms in the silicon fine particles.

In addition, when the electron transport layer is provided on the phosphor layer, the electrons can be effectively transmitted to the silicon fine particle. Furthermore, when the phosphor layer is sandwiched between the two electron transport layers formed of the material having the electron transport property, since the material serves as an electron hole stopper also, the transmitted electrons are not connected to the electron hole again, and the electrons can be effectively transmitted to the silicon fine particles.

According to the phosphor element of the present invention, at least one part of the surface of the silicon fine particle is covered with the conductive material, and the silicon fine particles are used as the light emitters. Thus, light can be emitted in the visible light region by the quantum effect and it can be chemically stabled. In addition, the phosphor element can be driven at the low voltage and the light can be emitted with high efficiency by the silicon fine particles.

### BRIEF DESCRIPTION OF DRAWINGS

These objects and other objects, features, aspects and advantages of the present invention will become more apparent from the following detailed description of the present invention when taken in conjunction with the accompanying drawings:

FIG. 1 is a sectional view showing a constitution of a phosphor element according to a first embodiment of the present invention;

FIG. 2 is a sectional view showing a constitution of a phosphor element according to an eighth embodiment of the present invention;

FIG. 3 is a perspective view showing an electrode constitution of a phosphor element according to a ninth embodiment of the present invention;

FIG. 4 is a schematic plain view showing a display device according to a tenth embodiment of the present invention;

FIG. 5 is a sectional view showing another constitution of a phosphor element according to a fourth embodiment of the present invention; and

FIG. 6 is a sectional view showing another constitution of a phosphor element according to an eighth embodiment of the present invention.

### DESCRIPTION OF THE PREFERRED EMBODIMENTS

Although a phosphor element according to embodiments of the present invention will be described in detail with reference to the accompanying drawings hereinafter, the present invention is not limited to the embodiments. In addition, the same reference numerals are allotted to substantially the same components in the drawings.

### First Embodiment

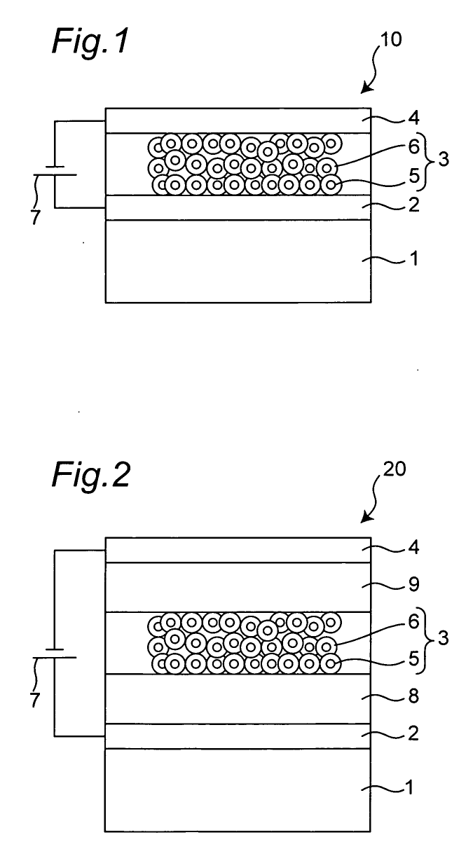

A phosphor element according to a first embodiment of the present invention will be described with reference to FIG. 1. FIG. 1 is a schematic view showing an element structure of the phosphor element 10. The phosphor element 10 has a phosphor layer 3 sandwiched between two first and second electrodes 2 and 4. According to a laminated relation of each layer, a transparent board 1 is provided as a substrate, and the first electrode 2, the phosphor layer 3 and the second electrode 4 are laminated in this order thereon in the phosphor element 10. In addition, light is emitted from the side of the transparent board 1.

In addition, in the phosphor element 10, although a luminescent color emitted from the phosphor element is determined by silicon fine particles which constitute the phosphor layer 3, a color conversion layer may be provided ahead of the phosphor direction of the phosphor layer 3 or a color conversion material may be mixed in a transparent conductor matrix in order to display multiple colors, or white color or to adjust color purity of each color and the like. Since the color conversion layer and the color conversion material may only have to emit light as an excitation source, it may be an organic material or an inorganic material, so that a well-known fluorescent material, a pigment, a dye and the like can be used. For example, when the color conversion layer which emits light in complementary color to that of the light from the phosphor layer 3 is provided, a surface light source which emits white light can be provided.

The luminescent characteristics of the phosphor element 10 will be described. Extracting electrodes from the ITO transparent electrode (first electrode) 2 and the Ag electrode (second electrode) 4, then, applying an external voltage between the ITO transparent electrode 2 and the Ag electrode 4 causes the phosphor element 10 to be emitted. In addition, according to the phosphor element in the first embodiment, a silicon fine particle surface having a particle diameter of 10 to 30 nm is covered with a titanium nitride film having a thickness of 10 to 30 nm. Next, a manufacturing method of the phosphor element 10 will be described. The phosphor element was manufactured according to the following procedures.
(a) A non-alkali glass substrate was used as the substrate 1. A thickness of the substrate 1 was 1.7 mm.
(b) The ITO transparent electrode 2 was formed on the substrate 1 using an ITO oxide target as the first electrode 2 by a RF magnetron sputtering method.
(c) The phosphor layer 3 in which the silicon fine particle 5 was covered with a conductive material 6 was formed on the ITO transparent electrode 2 by an evaporation method.
(d) The Ag electrode paste was screen-printed on the phosphor element 3 as the second electrode 4 and dried to form the second electrode 4.

According to the above steps, the phosphor element 10 was formed.

When the first electrode 2 and the second electrode 4 of the phosphor element 10 were connected to a positive electrode and a negative electrode of a DC power supply 7, respectively and a DC voltage was applied to them, bright emission at 4.5V was confirmed. Since the phosphor element 10 can be driven at a low voltage, a pixel can be controlled by the TFT

### Second Embodiment

A phosphor element according to a second embodiment of the present invention will be described. This phosphor element is the same as the phosphor element 10 according to the first embodiment other than that a particle diameter of a silicon fine particle 5 is different. The particle diameter of the silicon fine particle 5 was 5 to 20 nm.

When a first electrode 2 and a second electrode 4 of the phosphor element according to the second embodiment were connected to a positive electrode and a negative electrode of a DC power supply 7, respectively and a DC voltage was applied to them, bright emission at 3.6V was confirmed. Since the phosphor element according to the second embodiment can be driven at a low voltage, a pixel can be controlled by the TFT.

### Third Embodiment

A phosphor element according to a third embodiment of the present invention will be described. This phosphor element is the same as the phosphor element 10 according to the first embodiment other than that a particle diameter of a silicon fine particle 5 is different. The particle diameter of the silicon fine particle 5 was 70 to 100 nm. When a first electrode 2 and a second electrode 4 of the phosphor element according to the third embodiment were connected to a positive electrode and a negative electrode of a DC power supply 7, respectively and a DC voltage was applied to them, bright emission at 22V was confirmed. Since the phosphor element according to the third embodiment can be driven at a low voltage, a pixel can be controlled by the TFT

### Fourth Embodiment

A phosphor element according to a fourth embodiment of the present invention will be described. This phosphor element is the same as the phosphor element 10 according to the first embodiment other than that a conductive material 6 is a magnesium silver alloy. A molecule ratio of magnesium and silver was 10:1 and a film thickness was 5 to 50 nm. When a first electrode 2 and a second electrode 4 of the phosphor element according to the fourth embodiment were connected to a positive electrode and a negative electrode of a DC power supply 7, respectively and a DC voltage was applied to them, bright emission at 3.1V was confirmed. Since the phosphor element according to the fourth embodiment can be driven at a low voltage, a pixel can be controlled by the TFT.

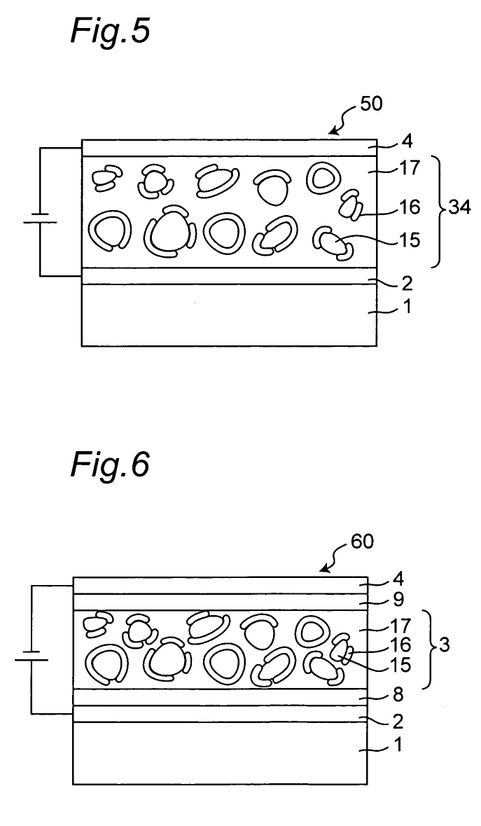

In addition, when a metal material is used instead of a semiconductor material as the conductive material which covers the silicon fine particles, it is preferable that not entire surface of the silicon fine particle but only a part of thereof is covered with the conductive material. In this case, as shown in FIG. 5, the phosphor layer 3 may be constituted by diffusing such silicon fine particles 15 in which a part of the surface is covered with a conductive material 16 formed of the metal material in a transparent conductor matrix 17 formed of a semiconductor material.

### Fifth Embodiment

A phosphor element according to a fifth embodiment of the present invention will be described. This phosphor element is the same as the phosphor element according to the fourth embodiment other than that a particle diameter of a silicon fine particle 5 is different. The particle diameter of the silicon fine particle 5 was 70 to 100 nm. When a first electrode 2 and a second electrode 4 of the phosphor element according to the fifth embodiment were connected to a positive electrode and a negative electrode of a DC power supply 7, respectively and a DC voltage was applied to them, bright emission at 19V was confirmed. Since the phosphor element according to the fifth embodiment can be driven at a low voltage, a pixel can be controlled by the TFT.

### Sixth Embodiment

A phosphor element according to a sixth embodiment of the present invention will be described. This phosphor element is the same as the phosphor element according to the third embodiment other than that a conductive material 6 is mainly formed of Ga₂0₃. A particle diameter of a silicon fine particle 5 was 70 to 100 nm. When a first electrode 2 and a second electrode 4 of the phosphor element according to the sixth embodiment were connected to a positive electrode and a negative electrode of a DC power supply 7, respectively and a DC voltage was applied to them, bright emission at 21V was confirmed. Since the phosphor element according to the sixth embodiment can be driven at a low voltage, a pixel can be controlled by the TFT

### Seventh Embodiment

A phosphor element according to an seventh embodiment of the present invention will be described. This phosphor element is the same as the phosphor element according to the sixth embodiment other than that a conductive material 6 is mainly formed of In₄Sn₃O₁₂. A particle diameter of a silicon fine particle 5 was 70 to 100 nm. When a first electrode 2 and a second electrode 4 of the phosphor element according to the seventh embodiment were connected to a positive electrode and a negative electrode of a DC power supply 7, respectively and a DC voltage was applied to them, bright emission at 16V was confirmed. Since the phosphor element according to the seventh embodiment can be driven at a low voltage, a pixel can be controlled by the TFT.

In addition, in the phosphor element according to the second embodiment to seventh embodiment, although a luminescent color is determined by silicon fine particles 5 which constitute the phosphor layer 3, a color conversion layer may be provided ahead of the phosphor direction of the phosphor layer 3 or a color conversion material may be mixed in the transparent conductor matrix in order to display multiple colors, or a white color or to adjust color purity of each color similar to the first embodiment.

### Eighth Embodiment

A phosphor element according to an eighth embodiment of the present invention will be described with reference to FIG. 2. FIG. 2 is a sectional view showing a constitution of a phosphor element 20. The phosphor element 20 is different from that in the first embodiment to seventh embodiment in that a first electron transport layer 8 is provided between a phosphor layer 3 and a first electrode 2, and a second electron transport layer 9 is provided between the phosphor layer 3 and a second electrode 4. Electrons can flow into the phosphor layer 3 well because of these electron transport layers 8 and 9. In addition, when the first electrode 2 and the second electrode 4 of the phosphor element according to the eighth embodiment are connected to a positive electrode and a negative electrode of a DC power supply 7, respectively, the first electron transport layer 8 provided on the side of the first electrode 2 functions as an electron hole stopper layer. As a material constituting the electron transport layers 8 and 9, there are two main types of an organic material such as a low-molecular material and a high-molecular material.

The low-molecular material including an electron transport property includes an oxadiazole derivative, a triazole derivative, a styrylbenzene derivative, a silole derivative, 1,10-phenanthroline derivative, a quinolinol series metal complex, a thiophene derivative, a fluorene derivative, a quinone derivative, and the like or their dimer or trimer. More preferably, although the following material may be used, the present invention is not limited to these, that is, 2-(4-biphenyl)-5-(4-tert-butylphenyl)-1,3,4-oxadiazole (PBD); 2,5-biss(1-naphtyl)-1,3,4-oxadiazole (BND); 2,5-bis[1-(3-methoxy)-phenyl]-1,3,4-oxadiazole (BMD); 1,3,5-tris[5-(4-tert-butylphenyl)-1,3,4-oxadiazole-2-yl]benzene (TPOB); 3-(4-biphenyl)-4-phenyl-5-(4-tert-butylphenyl)-1,2,4-triazole (TAZ); 3-(4-biphenyl)-4-(4-ethylphenyl)-5-(4-tert-butylphenyl)-1,2,4-triazole(p-EtTAZ); 4,7-diphenyl-1,10-phenanthroline (BPhen); 2,9-dimethyl-4,7-diphenyl-1,10-phenanthroline (BCP); 3,5-dimethl-3′,5′-di-tert-butyl-4,4′-diphenoquinone (MBDQ); 2,5-bis[2-(5-tert-butylbenzoxazolyl)]-thiophene (BBOT); trynitrofluorenone (TNF); tris(8-quinolinolato) aluminum (Alq3); and 5,5′-bis(dimesitylboryl)-2,2′bithiophene (BMB-2T) and the like.

In addition, the high-molecular material including the electron transport property includes poly-[2-methoxy-5-(2-etyhlhexyloxy)-1,4-(1-cyanovinylene) phenylene] (CN-PPV), polyquinoxaline, and a low-molecule polymer and the like incorporating a molecular structure which shows the electron transport property, in a molecular chain. Furthermore, molecules of the above low-molecular material may be diffused in a conductive or non-conductive polymer. In addition, a single-crystalline body of an n-type semiconductor material in which electrons can be well injected and there is no absorption in a visible light range as represented by zinc oxide (ZnO), indium oxide (In₂O₃), titanium oxide (TiO₂) and the like, its polycrystalline body, or a resin diffused layer of its particle powder and the like may be used.

In addition, when the metal material is used as the conductive material which covers the silicon fine particles instead of the semiconductor material, it is preferable that not entire surface of the silicon fine particle but only a part thereof is covered with the conductive material. In this case, as shown in FIG. 6, the phosphor layer 3 may be constituted by diffusing such silicon fine particles 15 in which one part of the surface is covered with a conductive material 16 formed of a metal material, in a transparent conductor matrix 17 formed of a semiconductor material.

### Ninth Embodiment

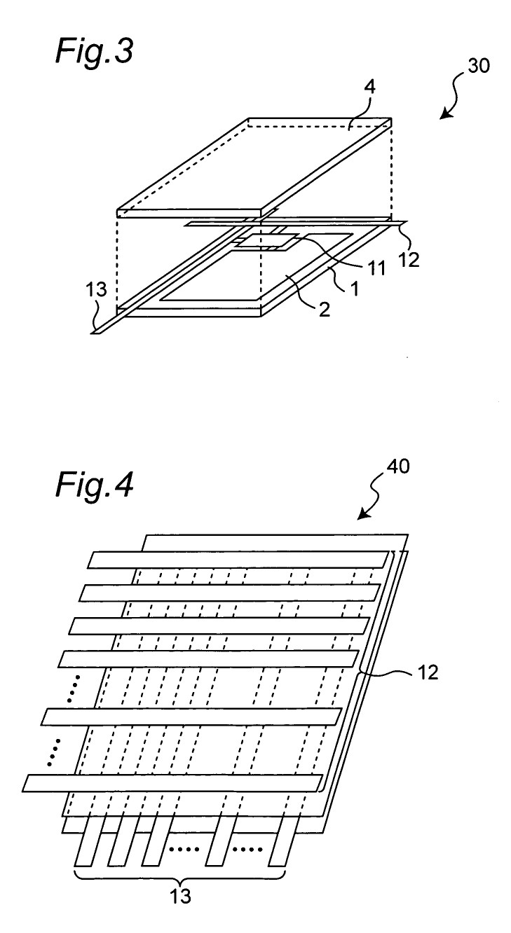

A phosphor element 30 according to a ninth embodiment of the present invention will be described with reference to FIG. 3. FIG. 3 is a perspective view showing an electrode constitution of the phosphor element 30. The phosphor element 30 further includes a thin film transistor 11 connected to the electrode 2 of the phosphor element according to the first embodiment to eighth embodiment. An x electrode 12 and a y electrode 13 are connected to the thin film transistor 11. According to the phosphor element 30, since at least a part of a surface of a silicon fine particle 5 is covered with a conductive material 6, it can be driven at a low voltage and the thin film transistor 11 can be used. In addition, when the thin film transistor 11 is used, the phosphor element 30 has a memory function. As this thin film transistor 11, low-temperature polysilicon or amorphous silicon thin film transistor and the like may be used. Furthermore, it may be an organic thin film transistor constituted by a thin film including an organic material, or may be a transparent thin film transistor formed of zinc oxide and the like.

### Tenth Embodiment

A display device according to a tenth embodiment of the present invention will be described with reference to FIG. 4. FIG. 4 is a schematic plain view showing an active matrix of the display device 40 which is constituted by x electrodes 12 and y electrodes 13 intersecting with each other. The display device 40 is an active matrix display device having a thin film transistor 11. The active matrix display device 40 includes a two-dimensional phosphor element array in which a plurality of phosphor elements 30 including the thin film transistors 11 shown in FIG. 3 are arranged, the plurality of x electrodes extending parallel to each other in a first direction which is parallel to a surface of the phosphor element array, and the plurality of y electrodes 13 extending parallel to each other in a second direction which intersects with the first direction at right angles. The thin film transistor 11 in the phosphor element connects the x electrode 12 to the y electrode 13. The phosphor element specified by the pair of x electrode 12 and y electrode 13 becomes a pixel. According to the active matrix display device 40, as described above, a phosphor layer 3 constituting the phosphor element of each pixel includes silicon fine particles 5 in which at least a part of its surface is covered with a conductive material 6. Thus, since it can be driven at a low voltage, the thin film transistor 11 can be used and a memory effect can be provided. In addition, since it can be driven at the low voltage, the display device has a long life. In addition, when the silicon fine particles 5 constituting the phosphor layer 3 are arranged in each pixel depending on its luminescent color (RGB), there can be provided a full-color display device using the three primary colors. In addition, a color filter may be provided ahead of the phosphor direction in order to adjust the color purity of each color of RGB. Furthermore, the phosphor layer 3 emitting one color to every pixel may be used, and a color conversion layer and the color filter may be further provided ahead of the phosphor direction. Thus, when the color conversion layer absorbs blue light generated from the phosphor layer 3, green or red light is generated and when they are taken out respectively, there can be provided a full-color display device using the three primary colors according to another example.

### COMPARATIVE EXAMPLE 1

A phosphor element according to a comparative example will be described. This phosphor element is the same as the phosphor element 10 according to the first embodiment other than that a particle diameter of a silicon fine particle is different and there is no conductive material on a surface. A particle diameter of a silicon fine particle in the comparative example 1 was 180 to 220 nm. When a first electrode 2 and a second electrode 4 of the phosphor element according to comparative example 1 were connected to a positive electrode and a negative electrode, respectively and a DC voltage was applied to them, bright emission at 103V was confirmed. Since the phosphor element according to the comparative example 1 is driven at a high voltage, it is difficult or impossible to control a pixel by the TFT

### COMPARATIVE EXAMPLE 2

A phosphor element according to a comparative example 2 will be described. This phosphor element is the same as the phosphor element 10 according to the first embodiment other than that a particle diameter of a silicon fine particle is different. A particle diameter of a silicon fine particle in the comparative example 2 was 200 to 240 nm. Although a first electrode 2 and a second electrode 4 of the phosphor element according to the comparative example 2 were connected to a positive electrode and a negative electrode, respectively and a DC voltage was applied to them, emission could not be confirmed even at 200V

### COMPARATIVE EXAMPLE 3

A phosphor element according to a comparative example 3 will be described. This phosphor element is the same as the phosphor element according to the fourth embodiment other than there is no conductive material. Although a first electrode 2 and a second electrode 4 of the phosphor element according to the comparative example 3 were connected to a positive electrode and a negative electrode, respectively and a DC voltage was applied to them, emission could not be confirmed even at 200V.

### COMPARATIVE EXAMPLE 4

A phosphor element according to a comparative example 4 will be described. This phosphor element is the same as the phosphor element according to the fourth embodiment other than a film thickness of a magnesium silver alloy is different and the film thickness is 60 to 100 nm. Although a first electrode 2 and a second electrode 4 of the phosphor element according to the comparative example 4 were connected to a positive electrode and a negative electrode, respectively and a DC voltage was applied to them, emission could not be confirmed even at 200V

### COMPARATIVE EXAMPLE 5

A phosphor element according to a comparative example 5 will be described. This phosphor element is the same as the phosphor element 10 according to the first embodiment other than a film thickness of titanium nitride which is the conductive material is different and the film thickness is 40 to 80 nm. Although a first electrode 2 and a second electrode 4 of the phosphor element according to the comparative example 5 were connected to a positive electrode and a negative electrode, respectively and a DC voltage was applied to them, emission could not be confirmed even at 200V.

As described above, although the present invention has been described in detail by the preferred embodiments, the present invention is not limited to the embodiments, and as will be understood by those skilled in the art, many preferred variations and modifications can be made in a technical scope of the present invention described in the following claims.

1. A phosphor element comprising:
a pair of electrodes opposed to each other; and
a phosphor layer sandwiched between the pair of electrodes and having silicon fine particles whose average particle diameter is not more than 100 nm,
wherein at least a part of a surface of the silicon fine particle is covered with a conductive material.

2. The phosphor element according to claim 1, wherein the conductive material comprises an oxide or a composite oxide containing at least one element selected from a group of indium, tin, zinc, and gallium.

3. The phosphor element according to claim 1, wherein the conductive material comprises a nitride or a composite nitride containing at least one element selected from a group of titanium, zirconium, hafnium, gallium, and aluminum.

4. The phosphor element according to claim 1, wherein the conductive material is titanium nitride whose thickness is not more than 30 nm.

5. The phosphor element according to claim 1, wherein the conductive material is magnesium silver alloy whose thickness is not more than 50 nm.

6. The phosphor element according to claim 1, further comprising an electron transport layer between the phosphor layer and at least one of the electrodes.

7. The phosphor element according to claim 1, further comprising a thin film transistor connected to at least one of the electrodes.

8. A display device comprising:
a two-dimensional phosphor element array in which the phosphor elements are arranged, each phosphor element comprising:
a pair of electrodes opposed to each other;
a phosphor layer sandwiched between the pair of electrodes and having silicon fine particles whose average particle diameter is not more than 100 nm, wherein at least a part of a surface of the silicon fine particle is covered with a conductive material; and
a thin film transistor connected to at least one of the electrodes;
a plurality of x electrodes extending parallel to each other in a first direction which is parallel to a surface of the phosphor element array; and
a plurality of y electrodes extending parallel to each other in a second direction which is perpendicular to the surface of the phosphor element array, and
wherein the thin film transistor of the phosphor element array connects the x electrode to the y electrode.
